(19) United States
(12) Patent Application Publication
(10) Pub. No.: US 2004/0060639 A1
(43) Pub. Date: Apr. 1, 2004

(54) Method of apparatus for ensuring uniform build quality during object consolidation

(76) Inventor: Dawn White, Ann Arbor,, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/640,089

(22) Filed: Aug. 13, 2003

Related U.S. Application Data
(60) Provisional application No. 60/403,049, filed on Aug. 13, 2002.

(51) Int. Cl. B32B 31/00

(52) U.S. Cl. 156/73.1; 156/64

(57) ABSTRACT

Apparatus and methods are directed to producing consistent bond-zone consolidation quality during additive manufacturing processes, even under constantly changing joining conditions, and regardless of location within the part being built. Various alternative techniques are disclosed involving the energy delivery to the bond zone, stiffness and mechanical resistance to vibration in the bond zone, and thermal conditions in the bond zone. These methods can be used independently or in combination, using a variety of control schemes, hierarchical or parallel. Also, although the examples generally employ a tape-type feedstock, these teachings apply equally well to sheet, tape, filament, dot type, and other feedstock geometries. In addition, although the invention is described in terms of Ultrasonic Object Consolidation (UOC), the disclosed apparatus and methods apply equally well to electrical resistance and frictional consolidation processes through appropriate engineering modification.

### REFERENCE TO RELATED APPLICATION

This application claims priority from U.S. Provisional Patent Application Serial No. 60/403,049, filed Aug. 13, 2002, the entire content of which is incorporating herein by reference.

### FIELD OF THE INVENTION

This invention relates generally to additive manufacturing and, in particular, to the control of bond-zone parameters in ultrasonic object consolidation and other such processes.

### BACKGROUND OF THE INVENTION

Numerous manufacturing technologies exist for producing objects by sequentially adding material, with the casting of liquid metal being perhaps the oldest such technique. In the past two decades, however, various processes for fabricating objects to net shape primarily through material addition, i.e. without a finishing step such as machining to produce detailed, high-precision features, have been patented and, in a few cases, commercialized.

Most of these additive manufacturing processes either rely on an adhesive, or a solidification process in order to produce a bond between previously deposited material and each incremental volume of material which is added. Although the use of adhesives is convenient, the properties of the adhesive control the properties of the finished object, and this limits the usefulness of such processes in the production of engineering parts and products.

Particularly with regard to the production of metal objects, prior-art methods based on solidification transformations require the presence of liquid metal. Various approaches to the problem include three-dimensional shape melting or shape welding, as described by Edmonds, U.S. Pat. No. 4,775,092, Doyle et al., U.S. Pat. No. 4,812,186, and Prinz et al., U.S. Pat. No. 5,207,371, and laser melting and deposition of powders as described in Lewis et. al., U.S. Pat. No. 5,837,960. Brazing of laminated objects, and closely related to it, infiltration of a low-surface tension and low-melting point alloy to fill voids in objects made by compacting or printing metal powders have also been employed, see U.S. Pat. No. 5,807,437 to Sachs; U.S. Pat. No. 5,872,714 to Shaikh; and U.S. Pat. No. 5,354,414 to Feygin. All of these processes require high temperatures and formation of liquid metals to produce a metal part.

Commonly assigned U.S. patent application Ser. No. 10/088,040, incorporated herein by reference in its entirety, is directed to a system and a method of fabricating an object by consolidating material increments in accordance with a description of the object using a process that produces an atomically clean faying surface between the increments without melting the material in bulk. In alternative embodiments, ultrasonic, electrical resistance, and frictional methodologies are used for object consolidation.

The material increments are placed in position to shape the object by a material feeding unit. The raw material may be provided in various forms, including flat sheets, segments of tape, strands of filament or single dots cut from a wire roll. The material may be metallic or plastic, and its composition may vary discontinuously or gradually from one layer to the next, creating a region of functionally gradient material. Plastic or metal matrix composite material feedstocks incorporating reinforcement materials of various compositions and geometries may also be used.

If excess material is applied due to the feedstock geometry employed, such material may be removed after each layer is bonded, or at the end of the process; that is after sufficient material has been consolidated to realize the final object. A variety of tools may be used for material removal, depending on composition and the target application, including knives, drilling or milling machines, laser cutting beams, or ultrasonic cutting tools.

The material increments are fed sequentially and additively according to a computer-model description of the object, which is generated by a computer-aided design (CAD) system, preferably on a layer-by-layer basis. The CAD system, which holds the description of the object, interfaces with a numerical controller, which in turn controls one or more actuators. The actuators impart motion in multiple directions. Three orthogonal directions may be used or five axes, including pitch and yaw as well as XYZ, may be appropriate for certain applications, so that each increment (i.e., layer) of material is accurately placed in position and clamped under pressure.

The system and method may incorporate the use of support materials to provide suitable substrates for any features of the object, which, when viewed sectionally, are overhanging. A description of the support resides in the CAD system, enabling the support to be built sequentially and additively. The support is preferably composed of less valuable material which is removed by stripping, cutting, dissolution, or by melting, when material having a lower melting-point than that of the object is used.

As examples, useful support materials include ceramics, particularly rapidly curing, water-soluble ceramics, and metal foils which do not bond but can be compressed so as to hold up the build portion. The support materials may be consolidated using the same power supply and different joining parameters, though not every layer or increment of the support need be bonded to the next layer, nor does the support need be fully consolidated. Indeed, weakly or partially bonded support material may be removed by breaking it up and shaking it loose using ultrasonic vibrations of appropriate frequency.

Other embodiments of the invention are directed to fabricating fiber-reinforced composites, including composites with continuous ceramic fibers in a metal matrix. According to one aspect, a layer of fibers is covered with a layer of a metallic powder, the surface of which is then partially consolidated by sweeping the surface with a laser beam. Full consolidation is effected using ultrasonic, electrical resistance, or frictional bonding techniques.

Another aspect is directed to fabricating an object by tape lay-up. Tape from a spool is fed and cut into segments to create successive sections of the object, the direction of the tape segments preferably alternating between two orthogonal directions from section to section. Material may also be provided in the form of wire or strip fed from a spool. Such a configuration is particularly applicable to repairing and overhauling worn or damaged regions of an object.

In many cases, small volumes of material are rapidly added to each other in order to produce random articles from featureless feedstocks. To produce parts with acceptable structural integrity, true physical bonds must be produced between the previously deposited material and each increment as it is added. Creating these bonds requires that energy be supplied to the part in some form.

During ultrasonic object consolidation (UOC), a very narrow zone of material sustains ultrasonically activated plastic flow. During this plastic flow, surface oxides on the build material are fractured and dispersed, allowing atomically clean metal surfaces to be exposed. As a result, dislocations can move across the interface between the previously built material and material being added, atomic diffusion is enhanced and a recrystallized grain structure is produced across the bond line, leading to a true metallurgical bond.

It is therefore critical during UOC to maintain consistent processing conditions as each volume of material is added to a growing part. As the geometry of the bond region is constantly changing during additive manufacturing processes, very different techniques are required to support this than are used in conventional ultrasonic joining processes, in which the geometry of the bond zone is constant and unvarying through many repetitions of the operation.

FIG. 1 is illustrative of the nature of additive manufacturing, in which parts are usually produced in layers—one cross section at a time. As the geometry of the cross sections change, the additive process involved must produce uniform material in the object, presenting process control challenges which differ greatly from those found in conventional series manufacturing. In the case of Ultrasonic Object Consolidation, the ultrasonic bonding process is both 1) continuous and, 2) constantly varying, as the geometry of any given part being produced changes, and as the geometry changes as different parts are produced from a random feedstock. It is clear that even in a simple geometry like the one depicted in FIG. 1, the amount of power required to uniformly consolidate a narrow section (B) will be less than that required in a wider section (A); in ultrasonic object consolidation, the process proceeds continuously across the region depicted requiring continuously varying welding power levels.

The sonotrode used in ultrasonic object consolidation is driven by an ultrasonic power train including a converter, booster and horn. The converter is typically a piezoelectric or magnetostrictive system which converts electricity into ultrasonic frequency motion. This motion is amplified by the booster to the desired amplitude range, and transmitted to a horn or sonotrode the shape of which is designed to deliver that frequency and amplitude of motion to a desired location while applying pressure to the workpiece. There is a characteristic power signal associated with the delivery of the ultrasonic energy to the workpiece which is observed under these circumstances.

The power used by the converter to produce this motion is a function of the mechanical impedance of the ultrasonic power train as a whole. The resistance to motion of the workpiece as it is translated against the substrate, and thus the power consumption, is a key indicator of bond quality. Ultrasonic welding requires that plastic deformation occurs in the bond zone; when insufficient relative motion and force are produced in the bond zone to cause plastic deformation and thus welding of the workpieces, a substantial drop in the power signal to the converter is observed, as shown in FIG. 2.

Other inventors have observed this phenomenon, and there have been attempts to control power to the ultrasonic power train in certain applications. U.S. Pat. No. 4,746,051 to Peter, for example, discusses a means of controlling an ultrasonic power transducer to achieve a specific energy level for a specific time period. Mims, U.S. Pat. No. 4,047,657, describes a means of monitoring the power of an ultrasonic welding process to determine when metallurgical bonding rather than oxide removal begins to occur, and executing a predetermined weld cycle in response. Mims is concerned with the issues associated with producing single parts, rather than a continuous bond, on continuously varying geometry, and fails to consider the special problems associated with this.

U.S. Pat. No. 4,984,730 to Gobel describes a means of controlling weld quality during wire bonding, a highly specialized ultrasonic welding application used in electronics manufacturing, employing deformation of the wire as a control signal for the ultrasonic welding power supply. U.S. Pat. No. 5,880,580 to Johansen describes a real-time control system employing feedback from a power signal as an input, and coupling it with the amplitude signal to achieve power input control of an ultrasonic welding system. U.S. Pat. Nos. 5,170,929 and 5,212,249, both to Long et al., are concerned also with the monitoring and control of ultrasonic weld quality during wire bonding. He claims means of monitoring and controlling the power to the ultrasonic system during wire bonding, including use of audible acoustic data as a means of process control.

However, all of these approaches concern themselves with the problem of producing high quality, reproducible welds on unvarying components. However, in certain types of additive manufacturing processes, the geometry associated with the region being consolidated may change on a continuous basis. In ultrasonic object consolidation, for example, the ‘bond zone’ between increments and layers is minute in comparison to the bulk of the part, making it difficult to maintain these uniform conditions, particularly as local weld geometry varies continuously. For example, for a feedstock 25 mm across, the bond zone dimensions will be approximately 0.2 to 0.5 mm³. This is a tiny volume of material, representing less than 0.0001% of the volume of a moderately sized object having dimension of 250×250×100 mm. Thus, there remains an outstanding need for methods of ensuring that consistent and uniform processing conditions are maintained, even in conjunction with very narrow bond zones.

During UOC, the interlaminar zone, a region consisting of an area approximately 5-10 microns on either side of the faying surfaces, undergoes substantial friction induced plastic deformation at temperatures, which while elevated above the ambient, are considerable lower than the melting point of the material.

In ultrasonic object consolidation, only a tiny volume of the material employed in the build is actually affected by the bonding process. UOC produces a bond zone only about 10-20 microns wide, and other deposited material is unaffected. As a result, minimal residual stresses evolve, and warping, dimensional changes, etc. are dramatically reduced. However, it is known that uniform thermal conditions are useful in ensuring consistent joint quality during ultrasonic welding.

U.S. Pat. No. 5,730,832 to Sato et al. contemplates the need to heat the sonotrode (as described by Renshaw) but disclose a means of heating the sonotrode via electrical resistance heaters disposed at the neutral points of the ultrasonic power train. They also describe the use of a hot air blower to provide heat to the assembly. U.S. Pat. No. 4,529,115 to Renshaw et al. teaches a means of preheating workpieces by heating the sonotrode and anvil (tooling) used to produce the ultrasonic weld. U.S. Pat. No. 5,142,117 to Hoggatt et al. teaches a means of heating an ultrasonic wire bonding tool in order to achieve more uniform weld quality.

All of the above teach the merits of heating sonotrodes and anvils in order to improve weld quality and consistency when articles of uniform geometry are to be repeatable produced in significant volumes, e.g., spot welding or aircraft components (Renshaw). These cases assume that the preheating of the sonotrode and anvil will suffice to raise the temperature in the weld zone to the desired range, as the welds are relatively small, local and discontinuous.

In the case of additive manufacturing, welds involved are continuous and non-local. Weld geometry is continuously varying, in that random objects are built up from featureless feedstocks via an incremental consolidation process. In the case of UOC, a featureless metal feedstock is bonded to previously deposited material using ultrasonic welding. As the geometry of the part being produced varies, both heat transfer, and mechanical restraint conditions can vary widely. Since rotating contact is used to provide a means of bonding the material and thermal conditions vary widely as a part is built. As a result, significantly different approaches are required to provide preheating during the build.

### BRIEF DESCRIPTION OF THE DRAWINGS

FIG. 1 is a diagram illustrating a simple geometry applicable to the principles of this invention;

FIG. 2 shows how the power level required to achieve bonding differs from those in a higher-aspect-ratio feature;

FIG. 3(a) shows a wide/low feature oriented in the direction of an ultrasonic vibration;

FIG. 3(b) shows a relatively narrow feature oriented perpendicular to the direction of an ultrasonic vibration;

FIG. 4 shows how certain locations in a given feature will vary in effective stiffness from the bulk of the feature, and how mechanical restraint affects local behavior in these situations;

FIG. 5 depicts a stepped buttress applicable to the invention; and

FIG. 6 is a depiction of possible methods for performing closed-loop control of the UOC process employing any one or more of the techniques described herein.

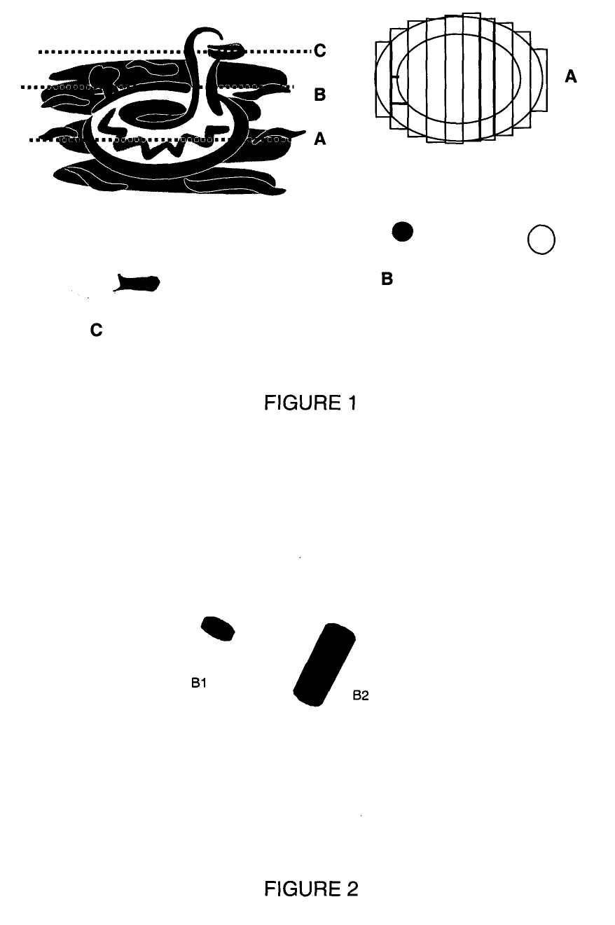

### SUMMARY OF THE INVENTION

This invention is directed to producing consistent bond-zone consolidation quality during additive manufacturing, even under constantly changing joining conditions, and regardless of location within the part being built. In various embodiments, the following are used to control processing conditions and maintain uniformity during additive manufacturing processes:

1. ensure consistent energy delivery to the bond zone.

2. establish consistent stiffness and mechanical resistance to vibration in the bond zone; and

3. maintain thermal conditions in the bond zone.

These methods can be used independently or in combination, using a variety of control schemes, hierarchical or parallel. Also, although the examples generally employ a tape-type feedstock, these teachings apply equally well to sheet, tape, filament, dot type, and other feedstock geometries. In addition, although the invention is described in terms of Ultrasonic Object Consolidation (UOC), the disclosed apparatus and methods apply equally well to electrical resistance and frictional consolidation processes through appropriate engineering modification.

### DETAILED DESCRIPTION OF THE INVENTION

As discussed in the Summary of the Invention, the following are used to control processing conditions and maintain uniformity during additive manufacturing processes:

1. ensure consistent energy delivery to the bond zone.

2. establish consistent stiffness and mechanical resistance to vibration in the bond zone; and

3. maintain thermal conditions in the bond zone.

These aspects will be considered individually, and in the order given above, with the understanding that these methods can be used independently or in combination, using a variety of control schemes, hierarchical or parallel. Also, although the examples generally employ a tape-type feedstock, this is exemplary only, and these teachings apply equally well to sheet, tape, filament, dot type, and other feedstock geometries. In addition, although the invention is described in terms of Ultrasonic Object Consolidation (UOC), the disclosed apparatus and methods apply equally well to electrical resistance and frictional consolidation processes through appropriate engineering modification.

### I. Consistent Energy to the Bond Zone

As discussed above, even when fabricating a part based upon a simple geometry, the amount of power required to uniformly consolidate a smaller section will be less than that required in a larger section. Nevertheless, in ultrasonic consolidation, the process proceeds continuously across the region depicted requiring continuously varying welding power levels. Ultrasonic bonding parameters such as applied force, amplitude, frequency and speed must be adjusted continuously in order to respond.

Calculation of Desired Parameters from a Predetermined Geometric Model

The local geometry of the part, such as current bond zone width, height of feature, location with respect to initiation or termination of a bond zone, can be calculated at any given instant from the geometry of the part being produced which is known. These data can be used to calculate weld parameters in real time, or used to refer to a look-up table containing previously identified parameters.

Use of Modern Adaptive Control Methods

The power required to drive the ultrasonic power supply to provide sufficient energy can be calculated based on the geometric methods mentioned above. Using the output signal of the power supply as a feedback signal, modern adaptive control methodologies such as Kalman filters, pole placement, etc. can be used to vary the welding parameters using some plant model, driving the power supply output to the desired level for the instantaneous consolidation conditions.

Use of Artificial Intelligence Methods

Various artificial intelligence techniques can be used to control systems to provide the necessary consistent power input discussed here. Rule-based systems, fuzzy logic, neural networks and genetic algorithms are examples of such methods. While differing in the methods used to accomplish a control objective, these and other advanced methods covered by the broad term “artificial intelligence” can be applied to this problem of generating constantly varying consolidation parameters to address constantly varying local geometric conditions.

### II. Control of Local Stiffness & Mechanical Resistance

The situation described above when considering the need to control the welding process as a function of the volume of material being consolidated is complicated still further because the geometry underlying any given bond volume being consolidated also affects the welding power required. For example, the power level required to achieve bonding differs from those in a higher-aspect-ratio feature, as shown in FIG. 2. Here the cross sections B1 and B2 have identical areas, but because of the geometry underlying them they will require different welding conditions to produce a high-quality uniform bond.

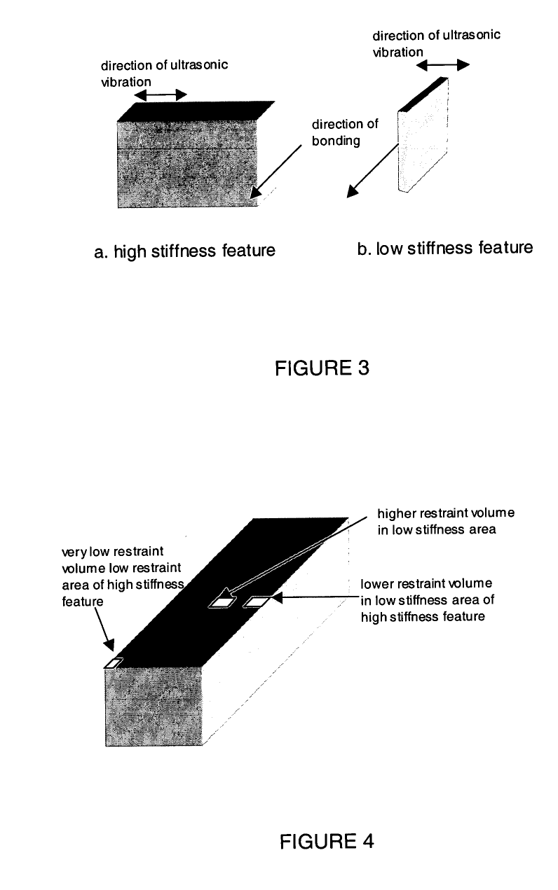

FIG. 3 provides another example of the difference between a wide low feature oriented in the direction of the ultrasonic vibration, and a relatively narrow feature oriented perpendicular thereto. The article depicted in FIG. 3(a) will have much higher stiffness than that depicted in FIG. 3(b). Ultrasonic consolidation parameters will vary accordingly. In addition, certain locations in a given feature will vary in effective stiffness from the bulk of the feature; mechanical restraint affects local behavior in these situations as illustrated in FIG. 4.

There are various ultrasonic consolidation parameters which can be used to compensate for these variations, including the applied force, the amplitude of the signal, and the welding speed. As geometry changes in the part, the mechanical resistance offered at any instantaneous location will vary. According to local stiffness, changes can be made to the controllable bonding parameters to assure that energy above the critical bonding level is delivered to the instantaneous bond zone. This can be done by varying the welding parameters according to local features such as initiations and terminations of bonded regions.

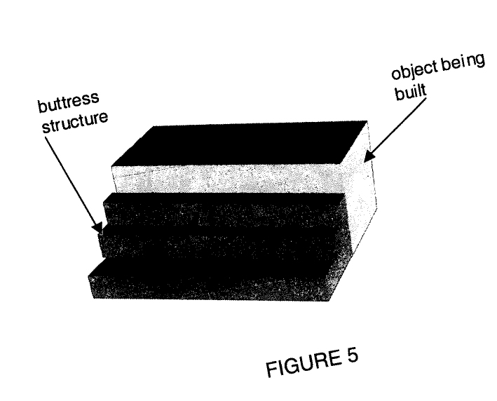

There are, in addition, other external means of controlling stiffness, such as buttresses and supports, which do not employ process control and are discussed herein. It may occasionally be desirable to provide an external buttress for an article being produced using additive object consolidation processes. These buttresses can be useful in ensuring that appropriate processing conditions exist on tall vertical walls as the part is built. A stepped buttress is a desirable embodiment of a structure of this type, as is shown in FIG. 5. The stepping maintains a uniform stress state at the outside face of the structure during build, particularly in corners where restraint on the article is at a minimum.

The stepped buttress illustrated is meant as an example only. Other geometries, such as arches or smooth “ramps,” can be used to produce a similar result, what is claimed is the addition of a stiffening feature which is easily removed during trimming and finishing operation. Further, although this feature is illustrated as being applied along an entire edge, support features can be continuous, intermittent, applied around corners, or only at corners, on the periphery of an entire part, or at the periphery of a specific feature on a larger part.

Although it is known to those experienced in the art that ultrasonic welding requires that the workpieces be rendered immobile with respect to the sonotrode and anvil, and that fixturing is provided during joining (just as it is for other welding process) the concept of using the ultrasonic joining process to actual build stiffening fixtures integrally in the process as is disclosed and illustrated here is a wholly novel approach.

In addition, secondary materials may be employed for a similar result. Such support materials, which I have described in other applications, are generally employed as a means of allowing overhanging and cantilevered features to be held up as they are formed, and are commonly used in additive manufacturing, having been described as early as by DiMatteo (U.S. Pat. No. 3,932,923). When the objective is to provide local stiffening, it is desirable, though not necessary, to have a material with a shear modulus which equals or exceeds that of the build material. If the material is to be dispensed as a liquid, it is of critical importance that it not shrink away from the surface of the feature to be supported, as a result of dimensional changes occurring upon solidification. Thus, a material with a zero or negative shrinkage upon solidification and a very small, zero, or negative coefficient of thermal expansion is highly desirable in such an application.

Further, such a material must melt at a temperature significantly lower than that of the build material, not be an aggressive solvent of the build material, and have sufficient strength at the consolidation temperature to be able to provide adequate compressive strength and stiffness when the ultrasonic consolidation process is being performed on the region being built.

Definition of Features for Local Parameter Determination

During object consolidation of featureless media to form objects having arbitrary shapes, various features on any given article being fabricated will be affected by the energy in ways which vary, but are predictable. As a result, it is desirable to vary consolidation parameters including, but not limited to speed, pressure and amplitude during processing.

For an automated process such as ultrasonic consolidation and other additive manufacturing processes, these process changes must be generated during creation of the machine program for each individual part. A suitable method for identifying features requiring such changes is needed. A grid is placed over the part design and used to identify the aspect ratio and volume of discrete features on the object. Such features must be treated independently, but may also be stacked upon each other, or interacting. Once discrete features are identified, their height to width ratios, and total volume are calculated and a look up table is employed to assign appropriate processing parameters. The requirement to incorporate or not incorporate a support or stiffening feature may also be generated through the use of such a grid.

Since bonding is not necessarily continuous during material addition, consideration must be given to the conditions at the initiation and termination of a bond. This situation occurs at the edge of a feature where feedstock deposition begins or ends. These conditions differ mechanically and dynamically from those prevailing during steady state bonding as a layer is deposited. As a result, special initiation and termination process parameters are used during bonding. These parameters may be functions of the location of the horn with respect to the feature being built, the instantaneous aspect ratio of the part as it is built, the width of the feature, ratio of feature width to tape width, etc. Typically these variations of force, speed, and ultrasonic wave amplitude will occur in the first 5-10 mm or final 5-10 mm of the component or feature being produced. They are used to compensate for variations in the solid mechanics of the component as its geometry changes, and for the need to initiate the moving flowing plastic flow front at the interface between previously deposited material and the volume of material being applied at any instant.

### III. Consistent Thermal Input

A constantly changing bond-zone geometry characterizes all types of additive manufacturing, particularly when random geometries are produced using featureless feedstocks. Since the geometry is constantly changing, the heat dissipation capability of the part is constantly changing as well. Accordingly, it has been found that to maintain a consistent build quality, it is desirable for the bond zone temperature to remain relatively constant. This ensures constant conditions for the moving plastic flow/recrystallization front to proceed with consistent, uniformly high quality.

This invention improves upon and extends additive manufacturing processes by directly or indirectly controlling the temperature of the bond zone so as to improve increment consolidation. Although no melting is involved with techniques such as ultrasonic, electrical resistance and frictional consolidation processes, control of the build temperature can improve build quality and process productivity. Indeed, even a slight elevation in temperature increases throughput while reducing the applied forces necessary to produce a bond.

Various apparatus and methods may be used for thermal control, including controlling the temperature of the build/part being produced, the substrate, the feedstock or the environment within the build chamber, so long as desired consolidation conditions are achieved. In the preferred embodiment, the bond zone is heated to a temperature near to the temperature of the feedstock, more preferably between 0.2 and 0.8 of the melting temperature of the feedstock material. Broadly, control of the local thermal history in the bond zone region(s) may take advantage of process parameter control, the use of supplementary thermal control methods or a combination thereof.

A number of techniques are possible according to the invention for controlling bond-zone temperature to within a desirable range. In the preferred embodiment, the temperature of the entire build is controlled to within the desired range. This allows the process to proceed without major, continuing changes in processing parameters directed to maintaining a constant bond zone temperature, as part geometry changes during the build. In this case, the invention uses a heat source secured to the build platform under the build base plate, as shown in the Figure. The heat source may assume various forms according to the invention, including electric base heaters mounted between a machine base plate and the part substrate. Other possible heating apparatus include, but are not limited to IR heaters, induction heaters, radiative heaters, strip heaters, resistance heaters, heat blankets, use of lasers, torches, electronic heaters, heating of the build chamber air, use of hot water, hot oil, steam etc. supplied through channels built into the growing object, etc.

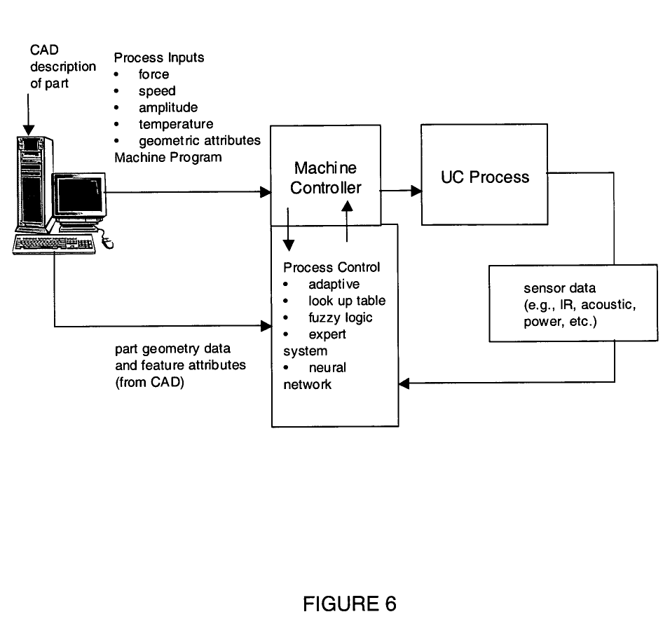

The heaters are preferably controlled by a closed-loop process-parameter control system. As shown in FIG. 6, one or more temperature sensing devices, which could be contacting (such as, but not limited to a thermometer or thermocouple-based device) or non-contacting (such as, but not limited to, an infra-red sensor) can be used to measure temperature in front of, behind, next to, or under the bond zone. This temperature is maintained constant by changing the consolidation pressure applied, the speed at which bonding is performed, the amplitude, or the frequency of vibration.

In an alternative embodiment, local rather than general heating of the part may be used to ensure that the bond zone reaches and stays within a desired temperature range. For instance, a focused heat source such as a laser, high intensity white light, etc., could travel along with the ultrasonic sonotrode, heating to the desired range only the region immediately being acted upon by ultrasonic energy to produce the bond zone. The purpose of this heating is not to produce any melting, but rather to ensure a uniform thermal history in the region of the part being produced at any given instant in any random build geometry. This could be used with process parameter control, as suggested above, or independently, or in combination with bulk part heating as illustrated in FIG. 2, to produce desired conditions in the bond zone.

In addition, it is possible to assist in generating a consistent thermal profile by heating of the feedstock, the sonotrode or both. These can be heated by a variety of methods, including, but not limited to those mentioned above as means of heating the previously consolidated material.

It is the intention of the present invention to incorporate both open and closed loop means of ensuring that the temperature remains within a set range, further a variety of advanced sensor driven control systems may be used to accomplish this, such as adaptive feedback, artificial intelligence, using local, remote, contacting or non-contacting temperature sensors to assure fidelity to the temperature requirements.

There are numerous control strategies for ensuring that the energy delivered to the bond zone remains above a critical level. For example, using the above grid-type methods, a look-up table of welding parameters to deliver appropriate energy levels could be applied to any given welding location. Alternatively, modern adaptive feedback control techniques could be employed to ensure that process inputs are controlled continuously and variably using mathematical process models to generate appropriate levels of energy input to the weld zone, with the power signal as feedback. Other artificial intelligence based control techniques, including but not limited to expert systems, fuzzy logic or neural networks could also be employed in the controller to the same ends. It is the intent of this to be exemplary only; one skilled in the art will appreciate the wide range of real-time control technologies available to apply to the problem, and it is the intent of the inventors to cover all of these methods for ensuring that the energy delivered to the bond zone via the ultrasonic power train remains above the critical level required to produce true metallurgical bonding.

Those skilled in the art will appreciate that the control of a continuous, constantly varying manufacturing process, with numerous inputs, outputs, sensing and process control techniques available can be implemented as an engineering activity in a number of ways. The schematic shown in FIG. 6 is a broad exemplary depiction of possible methods for performing closed loop control of the UOC process employing any one or more of the techniques described herein. Open loop control methods, while note illustrated here, are also possible implementations and are not meant to excluded by the more sophisticated example given.

I claim:

1. In an additive manufacturing process of the type wherein material increments are consolidated at a bond zone to produce a part, a method of maintaining uniformity in fabrication, comprising the following steps alone or in combination:
maintaining consistent energy delivery to the bond zone;
maintaining consistent stiffness and mechanical resistance to vibration in the bond zone; and
maintaining uniform thermal conditions in the bond zone.

2. The method of claim 1, wherein the step of maintaining consistent energy delivery to the bond zone includes the steps of:
determining the local geometry of the part being fabricated; and
using the local geometry to apply appropriate weld parameters.

3. The method of claim 2, including the step of specifying the local geometry in terms of current bond zone width, height of feature, or location with respect to initiation or termination of the bond zone.

4. The method of claim 3, wherein the appropriate weld parameters calculated in real time in accordance with the local geometry.

5. The method of claim 3, further including the use of a look-up table containing previously identified weld parameters.

6. The method of claim 3, further including the use of an adaptive control method to derive the level of energy required for a uniform weld at the bond zone.

7. The method of claim 6, wherein the adaptive control method is based upon a Kalman filter or pole placement.

8. The method of claim 6, wherein the adaptive control method is based upon artificial intelligence.

9. The method of claim 6, wherein the artificial intelligence technique is based on a rule-based system, fuzzy logic, neural network, or genetic algorithm.

10. The method of claim 1, wherein the step of maintaining consistent stiffness and mechanical resistance to vibration in the bond zone includes controlling applied force, the amplitude of the delivered energy, or welding speed.

11. The method of claim 1, wherein the step of maintaining consistent stiffness and mechanical resistance to vibration in the bond zone includes the use of initiation and termination process parameters during bonding.

12. The method of claim 11, wherein the initiation and termination process parameters are a function of the energy applied to the feature being built, the instantaneous aspect ratio of the part as it is built, the width of the feature, or the ratio of a feature dimension to feed dimension.

13. The method of claim 11, wherein the initiation and termination process parameters include force, speed, and/or ultrasonic wave amplitude.

14. The method of claim 11, wherein the initiation and termination process parameters are used to compensate for variations in the solid mechanics of the component as its geometry changes.

15. The method of claim 11, wherein the initiation and termination process parameters are used to initiate the moving flowing plastic flow front at the interface between previously deposited material and the volume of material currently being applied.

16. The method of claim 1, further including the steps of:
using a grid or other geometric map to identify the aspect ratio and/or volume of discrete features on the object;
finding height-to-width ratio and/or total volume based upon the aspect ratio and/or volume of the discrete features; and
assigning appropriate processing parameters as a function of height-to-width ratio and/or total volume.

17. The method of claim 16, wherein the processing parameters include speed, pressure and/or amplitude.

18. The method of claim 16, wherein the step of finding height-to-width ratio and/or total volume uses a look-up table.

19. The method of claim 16, further including the step of determining whether or not to incorporate a support or stiffening feature through the use of the grid or other geometric map.

20. The method of claim 1, further including the step of varying feedstock geometry to increase the degree of relative motion in the X-Z or Y-Z plane.

21. The method of claim 20, further including the step of using geometries which include an angle in the relevant directions.

22. The method of claim 1, wherein the step of maintaining consistent stiffness and mechanical resistance to vibration in the bond zone includes the use of a support feature which is conducive to easy removal during trimming and finishing of the part.

23. The method of claim 22, wherein the support feature is a stepped buttress.

24. The method of claim 22, wherein the support feature is continuous, intermittent, applied around corners, applied only at corners, on the periphery of an entire part, at the periphery of a specific feature on a larger part, or along an edge.

25. The method of claim 1, wherein the step of maintaining uniform thermal conditions in the bond zone includes controlling the temperature of the build/part being produced, the substrate, the feedstock or the fabrication environment.

26. The method of claim 22, wherein the bond zone is heated to a temperature near the temperature of the feedstock.

27. The method of claim 22, wherein the bond zone is heated to a temperature between 0.2 and 0.8 of the melting temperature of the feedstock material.

28. The method of claim 22, further including the step of controlling the local thermal history in the bond zone using process parameter control, supplementary thermal control, or a combination thereof.

29. The method of claim 22, wherein the temperature of the entire build is controlled to within a desired temperature range.

30. The method of claim 29, including the use of a heat source secured to a build platform.

31. The method of claim 22, wherein the beat source is an electric base heater, IR heater, induction heater, radiative heater, strip heater, resistance heater, heat blanket, lasers, torch, or electronic heater.

32. The method of claim 22, wherein the heat source includes the use of air, hot water, hot oil, or steam.

33. The method of claim 22, wherein the heat is supplied through channels built into the growing object, etc.

34. The method of claim 22, wherein the heat source is controlled by a closed-loop process-parameter control system.

35. The method of claim 22, wherein the closed-loop process-parameter control system uses contacting or non-contacting temperature sensors.

36. The method of claim 22, including the use of local as opposed to general heating of the part.

37. The method of claim 36, wherein the local heating is provided by a laser, or other high intensity light source.

38. The method of claim 37, wherein the local heating source travel along with an ultrasonic sonotrode.

39. The method of claim 22, including the step of generating a consistent thermal profile by heating of the feedstock, a sonotrode or both.

40. The method of claim 22, including the use of an open- or closed-loop technique for ensuring that the temperature remains within a set range.

41. The method of claim 40, wherein the technique includes a sensor driven control system based upon adaptive feedback or artificial intelligence.

42. The method of claim 40, wherein the technique includes the use of an expert system, fuzzy logic or neural network.

43. The method of claim 1, wherein the step of maintaining consistent stiffness and mechanical resistance to vibration in the bond zone includes the use of secondary materials.
